(19) United States
(12) Patent Application Publication
(10) Pub. No.: US 2006/0076239 A1
(43) Pub. Date: Apr. 13, 2006

(54) Electrophoresis apparatus

(76) Inventors: Ryoji Inaba, Hitachinaka (JP); Motohiro Yamazaki, Mito (JP); Akihiro Suzuki, Hitachinaka (JP); Miho Ozawa, Abiko (JP); Daizo Tokinaga, Hachioji (JP); Tomonari Morioka, Hitachinaka (JP); Seiichi Ugai, Hitachinaka (JP)

Correspondence Address: MCDERMOTT WILL & EMERY LLP, 600 13TH STREET, N.W., WASHINGTON, DC, 20005-3096, US

(21) Appl. No.: 11/245,491

(22) Filed: Oct. 7, 2005

(30) Foreign Application Priority Data
Oct. 7, 2004 (JP) 2004-295148

(51) Int. Cl. G01N 27/447

(52) U.S. Cl. 204/603; 204/600

(57) ABSTRACT

In an electrophoresis apparatus comprising capillaries for containing therein fluorescence-labeled substances, and a sensor for irradiating the capillaries with exciting light and detecting fluorescences, the sensor has a substrate including a datum surface for holding thereon the capillaries, and a groove sinking from the datum surface, and the groove has a plurality of reflecting surfaces for reflecting thereon the fluorescences emitted from the capillaries by a plurality of times.

### BACKGROUND OF THE INVENTION

The present invention relates to an electrophoresis apparatus for separating fluorescence-labeled substances such as DNA or the like to be analyzed by electrophoresis.

JP-A-2002-296235 discloses an electrophoresis apparatus. In this apparatus, a specimen including DNAs with marking by fluorochrome is introduced into capillaries juxtaposed to each other, and a laser beam is emitted to pass through the capillaries. The DNAs with marking by fluorochrome emit fluorescent lights caused by the laser beam irradiating the capillaries. The fluorescent light from each of the capillaries is detected to analyze the DNAs in the specimen introduced into each of the capillaries. Protein or the like is analyzed similarly. Further, a substrate holding the capillaries has a through-hole to restrain the light from being reflected.

JP-A-9-96623 discloses an electrophoresis apparatus in which capillaries are arranged in an optical transmittal medium of a predetermined refraction index to adjust a refraction and reflection of a laser beam on surfaces of the capillaries so that luminous energies reaching the specimens in the capillaries are adjusted. Further, techniques of arranging the capillaries in the optical transmittal medium is disclosed by U.S. Pat. No. 5,790,727, U.S. Pat. No. 5,582,705, U.S. Pat. No. 5,833,827 and JP-A-9-152418.

### BRIEF SUMMARY OF THE INVENTION

An object of the present invention is to provide an electrophoresis apparatus in which a crosstalk between capillaries can be reduced.

The invention relates to an electrophoresis apparatus in which capillaries are irradiated with an exciting light to detect fluorescent lights therefrom, and a groove or the like for reflecting by a plurality of times the fluorescent lights emitted from the capillaries is formed in a surface for holding the capillaries.

According to the invention, a reflecting light causing a crosstalk reaches a detector after surfaces of the groove or the like reflect the reflecting light by a plurality of times. Since an intensity of the reflecting light decreases in accordance with a number of reflections in the groove or the like, the intensity of the reflecting light to be detected by the detector is decreased to obtain data of fluorescent light intensity of decreased crosstalk.

For example, in an electrophoresis apparatus for detecting a substance with marking by fluorochrome by detecting a fluorescence emitted by the fluorochrome in a specimen, comprising,

capillaries each of which is capable of passing therein the substance,

a light source for irradiating the capillaries with a light so that the fluorochrome generates the fluorescence,

a sensor for detecting the fluorescence emitted from each of the capillaries, and

a substrate having a base planar surface along which parts of the capillaries are capable of being arranged to hold the other parts of the capillaries so that the other parts of the capillaries are capable of being irradiated with the light,

since the substrate has a fluorescence receiving surface arranged to receive thereon the fluorescences emitted from the other parts of the capillaries, prevented from extending perpendicular to the base planar surface, and prevented from extending parallel to the base planar surface,

a rate of a part of the fluorescences directly reaching at least one of the capillaries with respect to the fluorescences emitted from the other parts of the capillaries is reduced so that a reflected light proceeding into the capillaries is reduced to decrease a crosstalk between the capillaries.

If the substrate has another surface arranged to receive the fluorescences reflected by the fluorescence receiving surface so that the fluorescences emitted from the other parts of the capillaries are capable of being reflected by the substrate by at least two times when being prevented from reaching (before reaching) at least one of the capillaries, a rate of a part of the fluorescences reflected by the at least two times by the substrate with respect to the fluorescences emitted from the other parts of the capillaries is increased so that an intensity of the part of the fluorescences is significantly decreased by the reflections of the at least two times on the substrate to decrease a crosstalk between the capillaries.

It is preferable for decreasing the rate of the part of the fluorescences directly reaching at least one of the capillaries with respect to the fluorescences emitted from the other parts of the capillaries that as seen in a direction perpendicular to the base planar surface, the fluorescence receiving surface is arranged to overlap the other parts of the capillaries.

It is preferable for decreasing the rate of the part of the fluorescences directly reaching at least one of the capillaries with respect to the fluorescences emitted from the other parts of the capillaries that the capillaries have respective outer peripheral surface areas prevented from being coated with a solid resin, the other parts of the capillaries are included by the outer peripheral surface areas as seen in a direction perpendicular to longitudinal directions of the capillaries, and at least parts of the outer peripheral surface areas overlap the fluorescence receiving surface as seen in a direction perpendicular to the base planar surface.

It is preferable for increasing the rate of the part of the fluorescences reflected by the at least two times by the substrate with respect to the fluorescences emitted from the other parts of the capillaries that the capillaries have respective outer peripheral surface areas prevented from being coated with a solid resin, the other parts of the capillaries are included by the outer peripheral surface areas as seen in a direction perpendicular to longitudinal directions of the capillaries, and at least parts of the outer peripheral surface areas overlap the another surface as seen in a direction perpendicular to the base planar surface.

It is preferable for decreasing the rate of the part of the fluorescences directly reaching at least one of the capillaries with respect to the fluorescences emitted from the other parts of the capillaries that the fluorescence receiving surface is prevented from extending parallel to longitudinal directions of the parts of the capillaries.

It is preferable for decreasing the rate of the part of the fluorescences directly reaching at least one of the capillaries with respect to the fluorescences emitted from the other parts of the capillaries that the fluorescence receiving surface is prevented from extending parallel to a direction in which the parts of the capillaries are juxtaposed to each other on the base planar surface.

The fluorescence receiving surface and the another surface may form a groove on the substrate with respect to the base planar surface.

An optically transmissive medium other than the atmosphere may be received between the fluorescence receiving surface and the other parts of the capillaries. It is preferable that the optically transmissive medium is a liquid. If a difference in refractive index between a material forming the fluorescence receiving surface and the optically transmissive medium is smaller than a difference in refractive index between a material forming the fluorescence receiving surface and the atmosphere, it is preferable for decreasing the rate of the part of the fluorescences directly reaching at least one of the capillaries with respect to the fluorescences emitted from the other parts of the capillaries.

In an electrophoresis apparatus for detecting a substance with marking by fluorochrome by detecting a fluorescence emitted by the fluorochrome in a specimen, comprising,

capillaries each of which is capable of passing therein the substance,

a light source for irradiating the capillaries with a light so that the fluorochrome generates the fluorescence,

a sensor for detecting the fluorescence emitted from each of the capillaries, and

a substrate having a base planar surface along which parts of the capillaries are capable of being arranged to hold the other parts of the capillaries so that the other parts of the capillaries are capable of being irradiated with the light,

if an optically transmissive medium other than the atmosphere is capable of being received between the fluorescence receiving surface and the other parts of the capillaries, and a difference in refractive index between a material forming the fluorescence receiving surface and the optically transmissive medium is smaller than a difference in refractive index between a material forming the fluorescence receiving surface and the atmosphere, it is preferable for decreasing the rate of the part of the fluorescences directly reaching at least one of the capillaries with respect to the fluorescences emitted from the other parts of the capillaries.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is an explanation view showing schematically an electrophoresis apparatus.

FIG. 2 is an explanation view showing a structure of a light sensing part of the electrophoresis apparatus.

FIG. 3 is a view showing a first embodiment of a detector of the electrophoresis apparatus.

FIG. 4 is an explanation view showing a structure of the detector of the electrophoresis apparatus.

FIG. 5 is an explanation view showing a structure of capillaries of the electrophoresis apparatus.

FIG. 6 is a view showing a part of the detector of the electrophoresis apparatus of the invention.

FIG. 7 is an explanation view for explaining a crosstalk in two capillaries adjacent to each other.

FIG. 8 is a view for comparing in crosstalk the first embodiment of the detector of the electrophoresis apparatus of the invention with the conventional example.

FIG. 9 is a view showing a second embodiment of a detector of the electrophoresis apparatus.

FIG. 10 is a view for comparing in crosstalk the second embodiment of the detector of the electrophoresis apparatus of the invention with the conventional example.

FIG. 11 is a view showing a third embodiment of a detector of the electrophoresis apparatus.

FIG. 12 is a view showing a fourth embodiment of a detector of the electrophoresis apparatus.

FIG. 13 is a view showing a fifth embodiment of a detector of the electrophoresis apparatus.

FIG. 14 is a view showing a sixth embodiment of a detector of the electrophoresis apparatus.

### DETAILED DESCRIPTION OF THE INVENTION

Hereafter, the above mentioned and other novel distinctive features and benefits of the invention will be explained with making reference to the drawings. Incidentally, the drawings are used only for the explanation, but are not used to restrict the scope of the invention.

### EMBODIMENT 1

Hereafter, a first embodiment of an electrophoresis apparatus of the invention will be described.

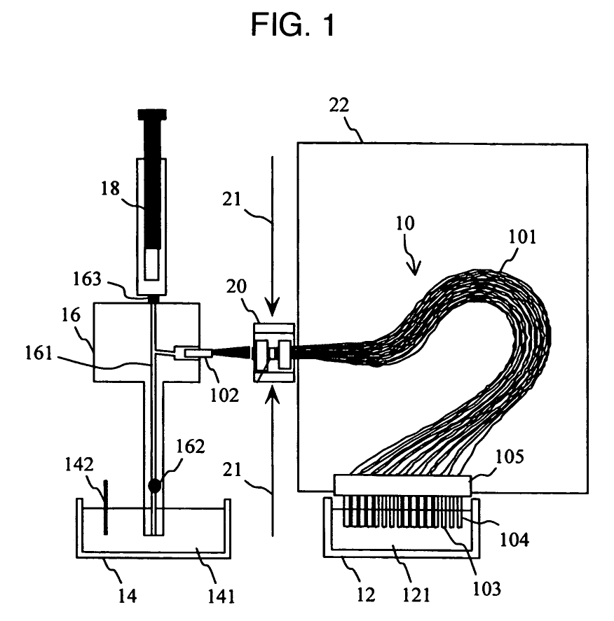

At first, with making reference to FIG. 1, an electrophoresis apparatus is briefly explained. The electrophoresis apparatus has a capillary array 10, a first buffer container 12, a second buffer container 14, a gel block 16, a syringe 18, a detector 20 and a thermostatic bath 22 for keeping a temperature of the capillary array at a constant temperature. By the thermostatic bath 22, the temperature of the capillary array 10 is kept at the constant temperature, for example, 60° C.

The capillary array 10 has a plurality of capillaries 101. A number of the capillaries 101 may be 48, 96 and so forth, but in this case is 48. The capillaries are formed by quartz glass tubes having inner diameters of dozens—several hundred micrometers and outer diameters of several hundred micrometers, and their surfaces are coated with polymer such as polyimide or the like. A structure of the capillaries will be explained below in detail with making reference to FIG. 5. Ends of the capillaries 101 are bound at a capillary head 102. The other ends of the capillaries, that is, cathode ends 103 are fitted in metallic tubular cathode electrodes 104, and front ends of the cathode ends 103 of the capillaries project from the cathode electrodes 104. The cathode electrodes 104 is mounted on a load header 105.

A first buffer liquid 121 is held by the first buffer container 12, and the cathode ends 103 of the capillaries and the cathodes electrodes 104 are immersed in the first buffer liquid 121. A second buffer liquid 141 is held by the second buffer container 14, and anode electrodes 142 are immersed in the second buffer liquid 141.

The gel block 16 has a tube 161, the syringe 18 is connected to an upper end of the tube 161 through a check valve 163, an lower end thereof is immersed in the second buffer liquid 141 of the second buffer container 14 through a valve 162. The capillary head 102 is mounted on a diverging point of the tube 161. By operating the syringe 18 and the valve 162, the polymer is injected from the syringe 18 into the capillaries 101 or removed therefrom. The polymer is refilled at every measurement to improve a performance of the measurement.

After the capillaries 101 are filled with the polymer 141, the first buffer container 12 is replaced by a sample plate, and the cathode ends 103 of the capillaries and the cathode electrodes 104 are inserted into specimens in the sample plate. When a voltage is applied between the cathode electrodes 104 and the anode electrode 142, DNAs in the specimens in the sample plate move in electrophoresis medium in the capillaries. Moving velocities of the DNAs vary in accordance with lengths, shapes and so forth of the DNAs. Therefore, the DNAs can be analyzed from difference in moving velocity between the DNAs separated from each other.

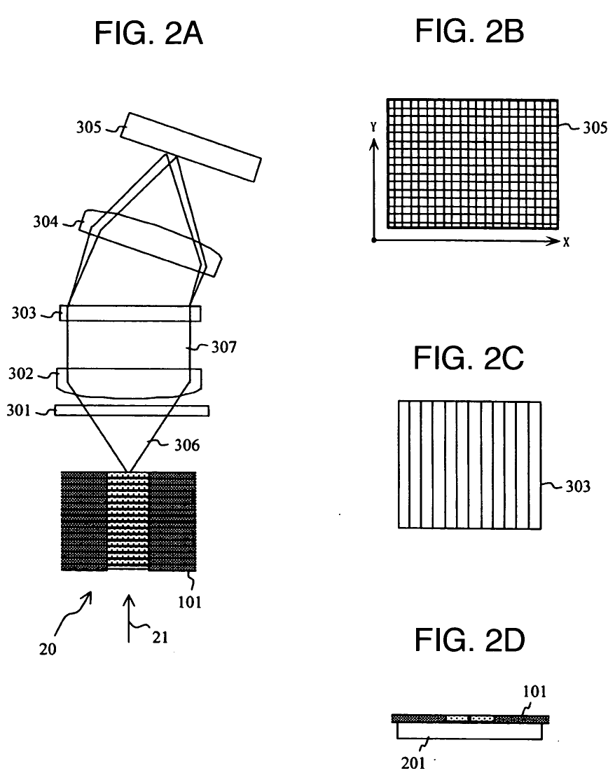

In the detector 20, the specimens moving in the capillaries 101 are irradiated with the laser beam 21. The DNAa with markings of fluorochromes in the specimens emits fluorescences generated by the laser beam. The fluorescences from the capillaries 101 are received by light sensors not shown. Accordingly, by measuring the fluorescences, the DNAs can be analyzed. Protein or the like can be analyzed similarly. Detail of the light sensors will be explained with making reference to FIG. 2.

The laser beam 21 is a coherent light, for example, a light of 488.0 or 514.5 nm from an argon iron laser.

As a method for emitting the laser beam to the capillaries, a multi-focus type, a scanning type, a batch emitting type and so forth are known. The multi-focus type will be explained below. The scanning type is a type in which, for example, an emitting direction of the laser beam is changed by a galvano mirror or a mirror reflecting the laser beam is moved to irradiate the capillaries in order by time intervals. Further, the batch emitting type is a type in which, for example, a sector light beam of the laser is used to irradiate simultaneously the capillaries.

The structure of the light sensor is explained with making reference to FIG. 2. As shown in FIG. 2a, the light (fluorescence) sensor (arranged to face to the parts of the capillaries without the coating or the parts of the capillaries irradiated optically to generate the fluorescence in the capillaries so that the parts of the capillaries without the coating or the parts of the capillaries irradiated optically to generate the fluorescence is arranged between the fluorescence sensor (particularly, a fluorescence receiving area of the fluorescence sensor mentioned below) and the fluorescence receiving surface, in a direction perpendicular to the planar datum surface 201A and/or longitudinal directions of the capillaries, and a fluorescence receiving area of the fluorescence sensor through which the fluorescence is taken into the fluorescence sensor overlaps the parts of the capillaries irradiated optically to generate the fluorescence and the fluorescence receiving surface of the substrate as seen in the direction) has a wavelength selection filter 301, a fluorescence condensing lens 302, a grating 303, a focusing lens 304 and a CCD 305. A polyimide coating is removed from the capillaries at the detector 20. When the parts from which the polyimide coating is removed is irradiated with the laser beam 21, the DNAs with the marking of the fluorochromes emit the fluorescences.

Lights 306 from the capillaries 101 pass firstly the wavelength selection filter 301. By the wavelength selection filter 301, the fluorescences are separated from the laser beam. The fluorescences are converted to collimated beams 307 by the fluorescence condensing lens 302, dispersed by the grating 303, and focused by the focusing lens 304 so that an image is formed on the CCD 305. FIG. 2b shows an arrangement of the CCD 305. Y coordinate indicates capillary numbers, and X coordinate indicates spectrums from the capillaries. FIG. 2c indicates serration direction of the grating 303, and FIG. 2d shows a cross sectional structure of a substrate 201 and the capillaries 101 thereon.

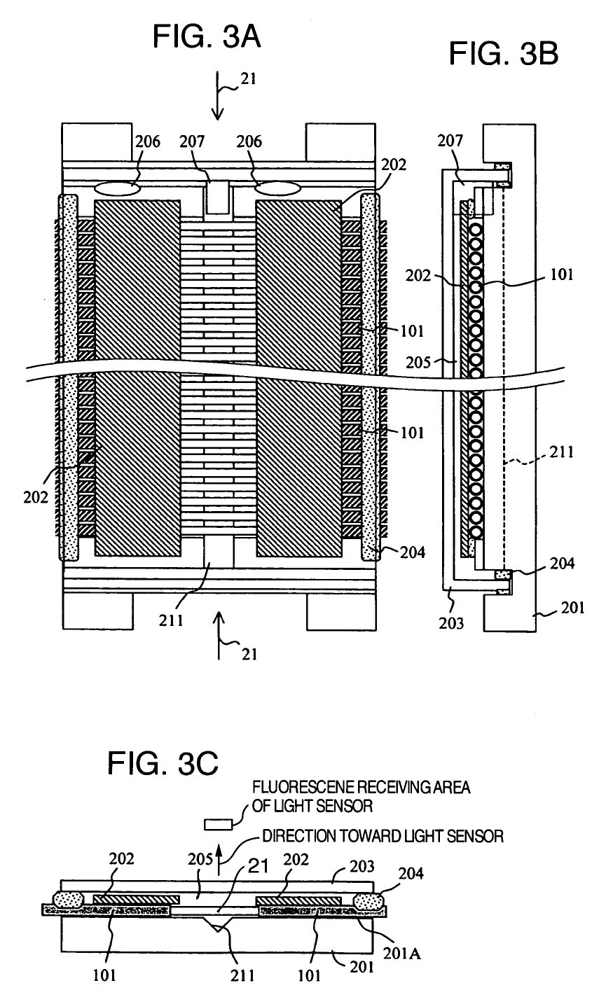

A first example of the detecting part is explained with making reference to FIG. 3. FIG. 3a is a front view, FIG. 3b is a longitudinally cross sectional view, and FIG. 3c is a transversely cross sectional view. The detector 20 has the substrate 201 arranged vertically, the capillaries 101 of total number 48 arranged horizontally on the substrate 101, pressing plates 202 holding the capillaries 101 on the substrate 201, and a cell cover 203 covering the capillaries. A V-shaped groove 211 of triangle cross section is arranged on the substrate 201 along an optical path of the laser beam 21. By these, in this example in which the V-shaped groove is arranged, a crosstalk is restrain, and a reason thereof will be explained below in detail.

The substrate 201 and the cell cover 203 are adhered to each other by an adhesive 204 so that a hermetically sealed container (cell) including therein a hermetically sealed cell is formed. The hermetically sealed cell is filled with a transparent optically transmissive medium 205. A bubble removing block 207 is arranged on a center of an upper end of the hermetically sealed cell, that is, on the optical path of the laser beam. Air bubble 206 in the optically transmissive medium 205 is arranged at the upper end to bypass the bubble removing block 207. By arranging the bubble removing block 207, the void 206 is prevented from being arranged on the optical path of the laser beam 21.

The optically transmissive medium 205 is used to prevent the laser beam from being reflected by quartz surfaces of the capillaries 101. Therefore, a refractive index of the optically transmissive medium is smaller than a refractive index of a quartz glass as a material of the capillaries, but has a value close thereto. In this example, the optically transmissive medium is Fluorinert® of refractive index 1.29. Therefore, the reflection of the laser beam on outer surfaces of the capillaries is prevented to restrain an attenuation of the laser beam incidentally, when the laser beam 21 is reflected on the outer surfaces of the capillaries, there is a provability of that a part thereof reaches the polymer coating so that the polymer coating emits the fluorescence. But, the fluorescence from the polymer coating is shielded by the pressing plates 202 to be prevented from reaching the light sensor. Therefore, a high accuracy detection of high SN ratio is obtainable.

A method for mounting the capillaries is explained with making reference to FIG. 3c. The substrate 201 made of the quartz glass has a planar datum surface 201A for holding the capillaries. The capillaries of total number 48 are arranged on the datum surface 201A, and the pressing plates 202 are arranged thereon. Accordingly, the capillaries 101 arranged between the datum surface 201A and the pressing plates 202 to be stationary. All of central axes of the capillaries of total number 48 are substantially on a common plane. An error in distance between the datum surface 201A and the central axes of the capillaries can be limited to not more than 6 μm. Incidentally, the capillaries may be mounted by another method. For example, a holding member having V-shaped grooves for holding the capillaries may be used. Both sides with respect to the parts of the capillaries from which the coating is removed may be held by the holding member.

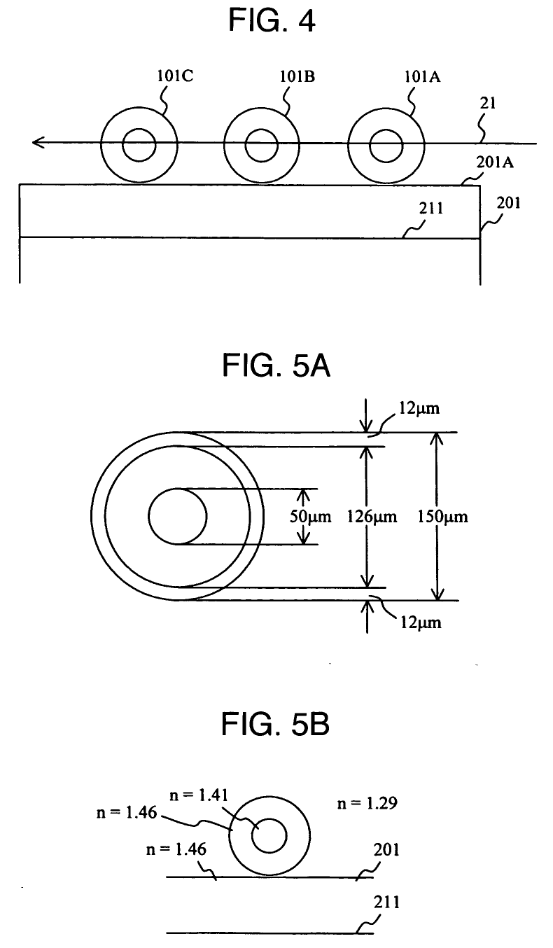

FIG. 4 is a cross sectional view showing schematically a part of the sensor and taken along a plane perpendicular to the capillaries. Although the total number of the capillaries is 48, only three capillaries 101A, 101B and 101B are shown here. The laser beam 21 firstly irradiates end one 101A of the capillaries, and after passing it, irradiates subsequent one 101B of the capillaries. In this manner, the laser beam passes the capillaries in order, and propagates from the other end one of the capillaries. Since the capillaries have cylindrical shapes and are filled with the polymer, they have condensing performance similarly to a convex lens. Therefore, a divergent of the laser beam is restrained. By emitting the laser beams from both upward and downward directions, all of the capillaries can be irradiated with a constant intensity of the laser beams.

Since the laser beam 21 passes the vicinity of the central axes of the capillaries of total number 48, a loss of the laser beam caused by the refraction and reflection is restrained.

The structure of the capillary is explained with making reference to FIG. 5. In an example of FIG. 5a, the capillary is formed by a quartz glass tube of inner diameter 50 μm and outer diameter 126 μm, and a polymer coating of thickness 12 μm, and an outer diameter of the polymer coating is 150 μm. FIG. 5b shows examples of refractive indexs of the capillary and substance surrounding it. The polymer coating is removed in the detector to expose the quartz glass tube. The refractive index of the quartz glass forming the capillary is 1.46, and the refractive index of the polymer water solution as the electrophoresis medium in the capillary is 1.41. The capillary is arranged in the optically transmissive medium. When the Fluorinert® is used as the optically transmissive medium, its refractive index is 1.29. Incidentally, if the substrate 201 is made of the quartz glass similarly to the capillary, its refractive index is 1.46.

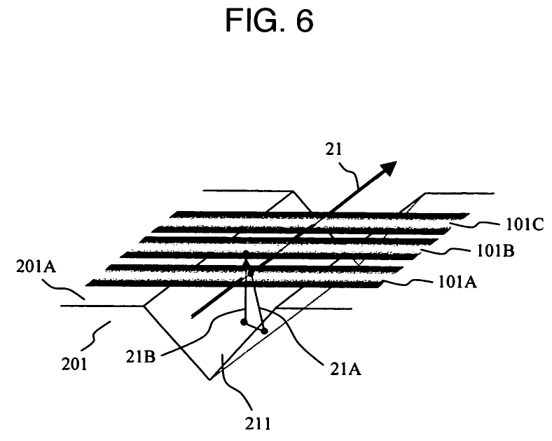

The distinctive feature of the electrophoresis apparatus of this example is explained with making reference to FIG. 6. FIG. 6 shows the substrate 201 and the parts of the capillaries arranged on the substrate in the sensor of the electrophoresis apparatus. In the electrophoresis apparatus shown in FIG. 6, the V-shaped groove 211 of the triangle cross section is formed on a main surface of the substrate along an optical axis of the laser beam 21 perpendicular to the capillaries. Although the total number of the capillaries 101 is 48, only three 101A, 101B and 101C of them are shown here. In this example, the capillaries are irradiated with the laser beam of the multi-focusing type. The laser beam is emitted to pass the vicinity of the central axes of the capillaries and to be substantially perpendicular to the capillaries. In the multi-focusing type, the laser beam is emitted substantially parallel to the surface on which the capillaries are arranged.

A reflectance α of an interface between a substance of refractive index n₀ and a substance of refractive index n₁ is calculated along the following formula, if an incident angle is 90 degrees.
α=[(n₀−n₁)/(n₀+n₁)] (formula 1)

When n₀ is the refractive index 1.29 of the Fluorinert® and n₁ is the refractive index 1.46 of the quartz glass as the substrate, the reflectance α is α×100%=0.38%. That is, about 0.4% of the fluorescence emitted to a bottom of the substrate is reflected. Incidentally, if n₀ is the refractive index 1.00 of the atmosphere, the reflectance α is α×100%=3.49%. Whereby, the fluorescence reflected by the bottom surface of the groove 210 causes the crosstalk of the fluorescence signal from the neighboring capillary.

The crosstalk in the electrophoresis apparatus of this example in FIG. 6 is explained. In the electrophoresis apparatus of this example, It is known that the crosstalk in the electrophoresis apparatus of this example is smaller in comparison with the prior art electrophoresis apparatus. A reason for this is that the fluorescence emitted from the capillary is reflected by two inner walls of the V-shaped groove by turns to be attenuated. As shown in the drawing, the fluorescence 21A from the capillary 101A is reflected in the V-shaped groove 211 and subsequently the reflected light 21B reaches the neighboring capillary 101B. Before the fluorescence 21A from the capillary 101A reaches the neighboring capillary 101B, it is reflected by at least two times. The intensity of the light 21B reflected by two times can be obtained by squaring the value of the formula 1 if neglecting an angular dependency. When the Fluorinert® is used as the optical transmissive medium, the intensity of the light 21B reflected by two times becomes 0.00146% of its original intensity, that is, substantially negligible level. If the optical transmissive medium is not used, the intensity of the light 21B reflected by two times becomes 0.122% of its original intensity, that is, substantially negligible level similarly.

An angle of the V-shaped groove 211 may have various value which satisfy the at least two times reflection of the fluorescence emitted from the capillary. The smaller the angle is, the greater a total number of reflections is. But, if the angle of the V-shaped groove is decreased with maintaining a width of the groove unchanged, a depth of the groove needs to be increased so that a thickness of the substrate needs to be increased. If the angle of the groove is decreased with maintaining the depth of the groove unchanged, the width of the groove is decreased to decreased an amount of the fluorescence emitted into the groove.

It is preferable that the surfaces of the V-shaped groove are mirror surfaces. If the surfaces of the V-shaped groove are not the mirror surfaces, for example, are frosted-glass surfaces, proceeding directions of the reflected light become isotropic so that scattered component returning toward the capillary increases to increase the crosstalk.

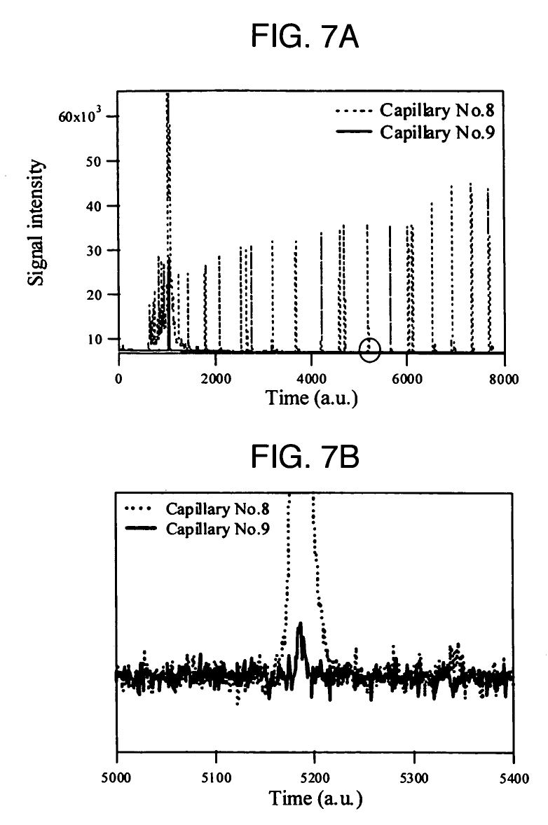

A measured value of the crosstalk generated on the capillary of the prior art electrophoresis apparatus is explained with making reference to FIG. 7. An ordinate of FIG. 7 is an intensity of a light signal received by the optical sensor, and an abscissa thereof is an electrophoresis time period (desired unit). Here, the fluorescence signals from the capillaries adjacent to each other are measured. The electrophoresis of the specimen including the DNA with the marking by fluorochrome is performed in the capillary 8. The electrophoresis of an empty specimen not including the DNA with the marking by fluorochrome is performed in the capillary 9. A diagram indicated by a broken line in FIG. 7a shows the fluorescence signal from the capillary 8. A diagram indicated by a solid line shows the signal from the capillary 9.

FIG. 7b is an enlarged view of a part of FIG. 7a surrounded by a circle. It is known that the signal from the capillary 9 shown by the solid line is the crosstalk of the signal of the capillary 8. If a peak signal is on the same level as the crosstalk, the detecting accuracy of the fluorescence signal is decreased. The inventors of the present application considered as to how the fluorescence from the capillary overlaps the fluorescence from the adjacent capillary. As a result of this, it was found that the crosstalk includes at least the fluorescence reflected by the substrate.

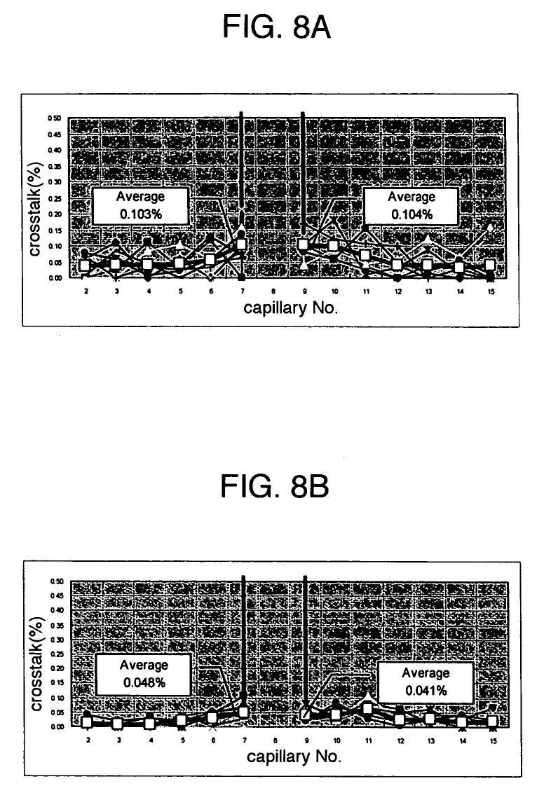

An example of the measured crosstalk generated on the capillaries adjacent to each other is explained with making reference to FIG. 8. An ordinate indicates a capillary number, and an abscissa indicates the intensity of the signal. The electrophoresis of the specimen including the DNA with the marking by fluorochrome is performed in the capillary 8. The electrophoresis of the empty specimen not including the DNA with the marking by fluorochrome is performed in the capillaries other than the capillary 8. Therefore, the signal from the capillaries other than the capillary 8 is the crosstalk. FIG. 8a shows an experimental result in the electrophoresis apparatus having a groove of rectangular cross section, and FIG. 8b shows an experimental result in the electrophoresis apparatus having the V-shaped groove shown in FIG. 6. Lines in the line chart shows a plurality of the experimental results. White rectangular shapes show an average value of the plurality of the experimental results.

In the result of the prior art apparatus shown in FIG. 8a, the average value of the crosstalk from the capillary 7 adjacent to the capillary 8 was 0.103%, and the average value of the crosstalk from the capillary 9 adjacent to the capillary 8 was 0.104%. In the result of the apparatus of the example shown in FIG. 8b, the average value of the crosstalk from the capillary 7 adjacent to the capillary 8 was 0.048%, and the average value of the crosstalk from the capillary 9 adjacent to the capillary 8 was 0.041%. It is known that the crosstalk is significantly reduced in the example.

### EMBODIMENT 2

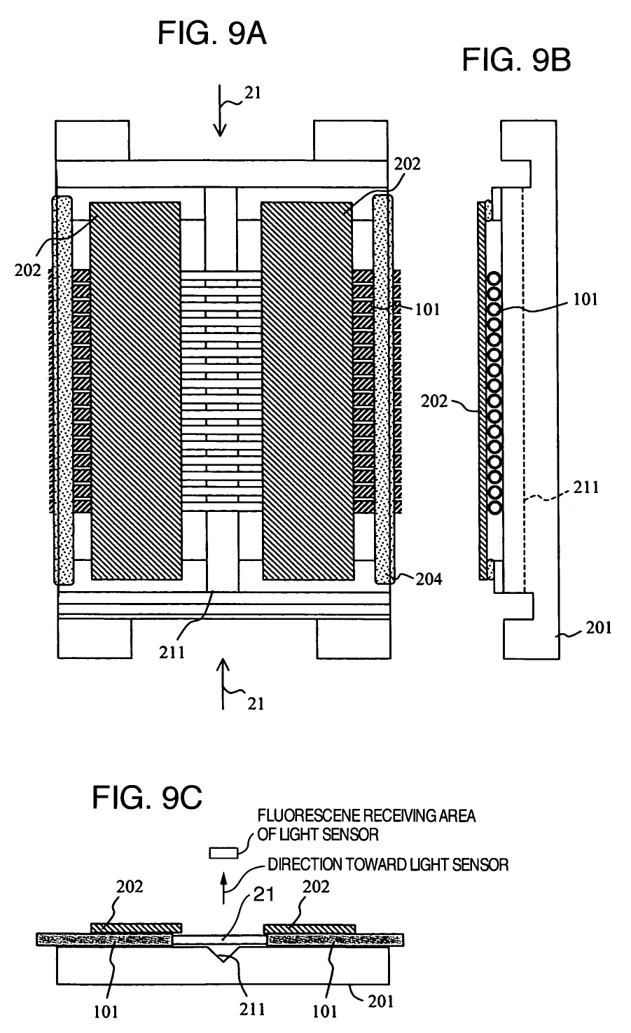

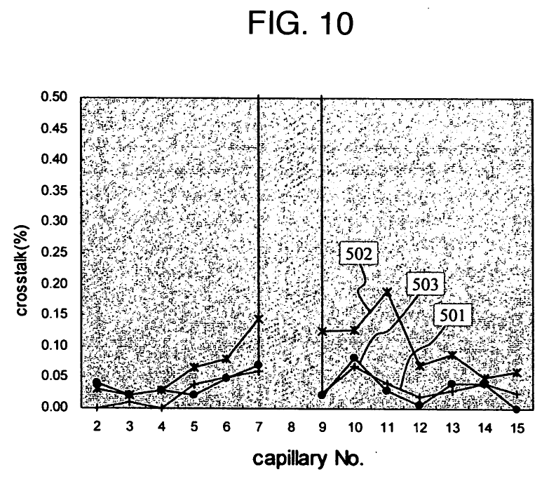

A second embodiment of the sensor of the electrophoresis apparatus of the invention is explained with making reference to FIG. 9. FIG. 9a is a front view, FIG. 9b is a longitudinal cross sectional view and FIG. 9c is a transverse cross sectional view.

The electrophoresis apparatus of this embodiment is different from the first embodiment of the electrophoresis apparatus of this embodiment shown in FIG. 3, in that (1) the optical transmissive medium is not used and (2) a total number of the capillaries is 16. Since the optical transmissive medium is not used, the cell cover 203 is eliminated. The capillaries are surrounded by the atmosphere at the optically irradiated areas where the polymer coating is removed. In this case, the laser beam reflected by the surfaces of the capillaries is greater in comparison with a case in which the optically transmissive medium is used. The laser beam is attenuated when passing through the capillaries. In this case, the total number of the capillaries is 16.

FIG. 10 is a diagram for comparing in crosstalk between the second embodiment of the electrophoresis apparatus and the prior art electrophoresis apparatus. A line 501 shows the crosstalk in the electrophoresis apparatus of the embodiment, a line 502 shows the crosstalk in the prior art electrophoresis apparatus having the groove of rectangular cross section, and a line 503 shows the crosstalk in the prior art electrophoresis apparatus having a through hole in the substrate. As apparent from a comparison with the lien 501 and the line 502, the crosstalk in the electrophoresis apparatus of the embodiment is significantly low. In the electrophoresis apparatus having the through hole in the substrate, the crosstalk is low similarly to the embodiment. A reason for this is that the fluorescence causing the crosstalk is emitted to the outside through the through hole to be prevented from overlapping the fluorescence of the neighboring capillary.

### EMBODIMENT 3

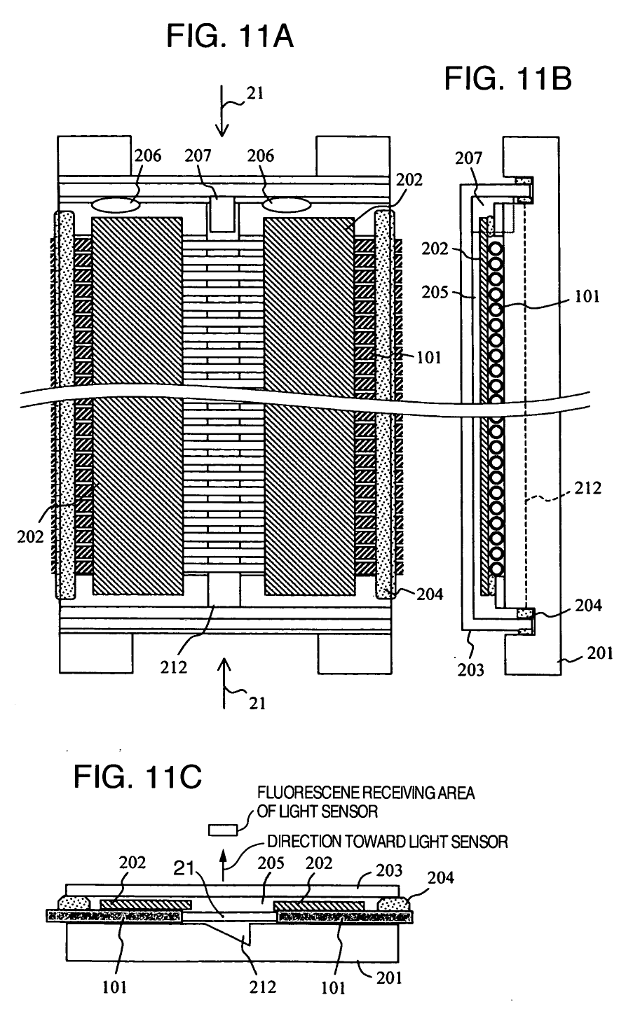

FIG. 11 shows a third embodiment of the sensor of the electrophoresis apparatus of the invention. In the third embodiment, a cross section of the groove 212 is a right angled triangle, and has the same shape as a right angled rule including an angle of 60 degrees. That is, a first inner wall of the groove 212 is perpendicular to the datum surface of the substrate, and a second inner wall of the groove 212 is inclined by about 30 degrees with respect to the datum surface of the substrate.

### FOURTH EMBODIMENT

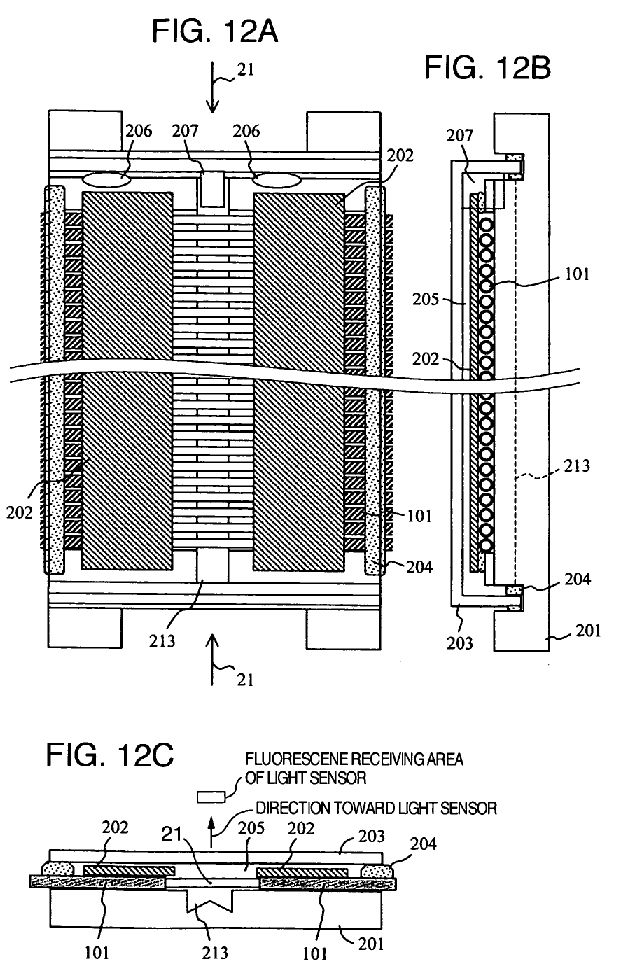

FIG. 12 shows a fourth embodiment of the sensor of the electrophoresis apparatus of the invention. In the fourth embodiment, a cross section of the groove 213 is polygonal, and has four inner walls, that is, two inner walls perpendicular to the datum surface of the substrate and two bottom surfaces inclined with respect to the datum surface of the substrate.

Since the inner surface of the groove of the embodiments of FIGS. 11 and 12 has a plurality of the surfaces inclined with respect to the datum surface of the substrate, the fluorescence emitted from the capillary reaches the other capillary after being reflected by a plurality of times, so that the crosstalk is reduced. Here, although the two examples of the cross sectional shapes of the groove is shown, the cross sectional shape of the embodiment is not limited to these examples. That is, the cross sectional shape of the embodiment may have various polygonal shape including the reflecting surfaces inclined with respect to the datum surface of the substrate to enable the fluorescence to be reflected by the plurality of times.

### FIFTH EMBODIMENT

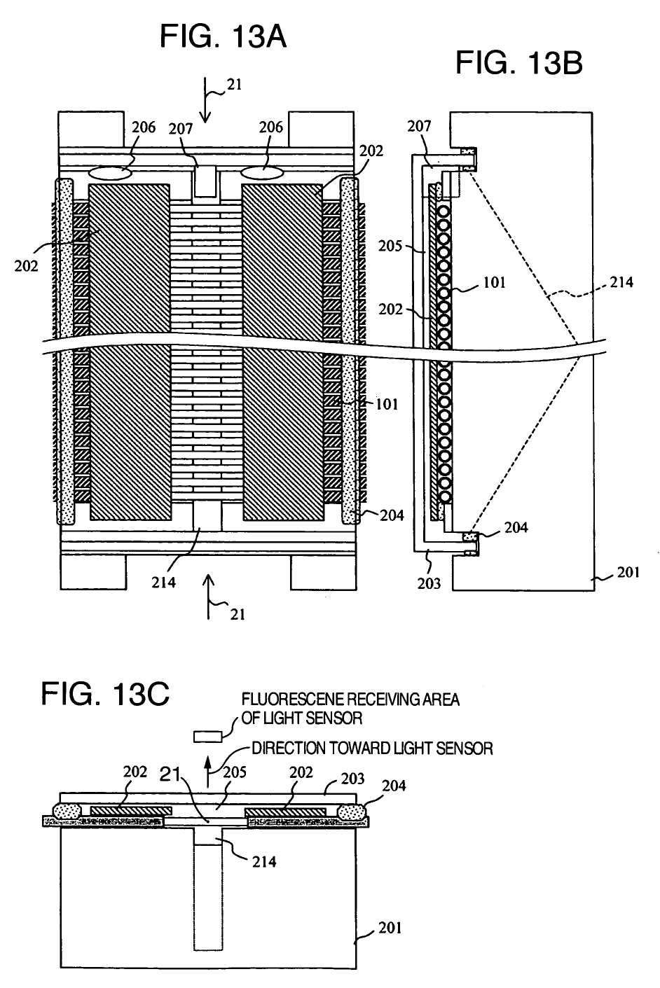

FIG. 13 shows a fifth embodiment of the sensor of the electrophoresis apparatus of the invention. In this embodiment, a groove 214 formed in the substrate has a rectangular cross section, and a bottom surface of the groove 214 is inclined. In this embodiment, the fluorescence emitted from the capillary is reflected by the plurality of times by the inclined bottom surface of the groove. Therefore, a quantity of a part of the fluorescence emitted from the capillary and overlapping the neighboring capillary is decreased to decrease the crosstalk.

### SIXTH EMBODIMENT

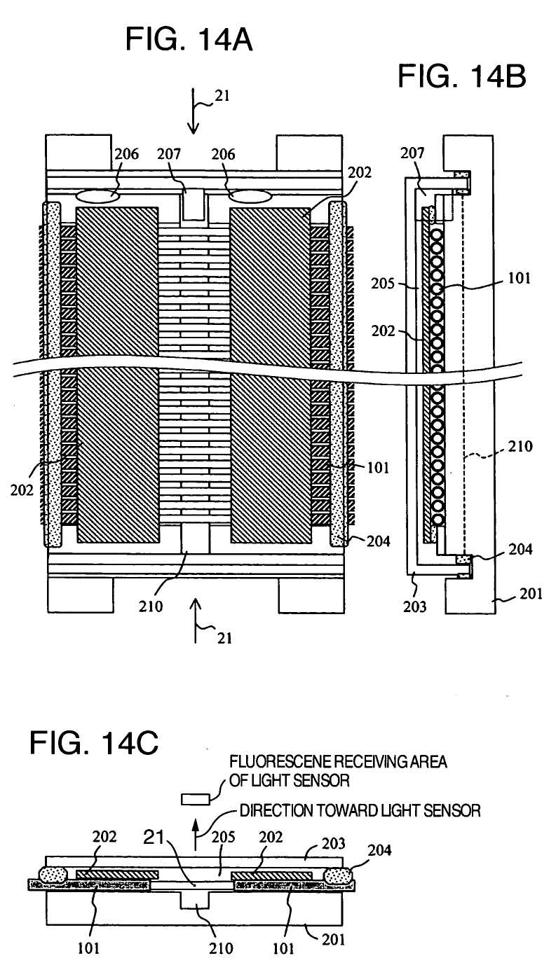

FIG. 14 shows a sixth embodiment of the sensor of the electrophoresis apparatus of the invention. The sensor of the electrophoresis apparatus of the invention is differentiated from the prior art electrophoresis apparatus by a material of the substrate of the electrophoresis apparatus of the invention. The other structure other than the material may be equal to each other. In the electrophoresis apparatus of the invention, the substrate of the sensor has the same or substantially same refractive index as the optically transmissive medium. When the Fluorinert® is used as the optical transmissive medium, the substrate is made of a substance having the refractive index 1.29 equal to that of the Fluorinert®. As such substance, for example, a fluorochemical polymer resin of AF2400® (refractive index 1.29) or AF1600® (refractive index 1.31) provided from Dupont Inc. exists.

By making the refractive index of the substrate and the refractive index of the optically transmissive medium equal or substantially equal to each other, the reflection of the fluorescence on the surface of the substrate is prevented. That is, in this embodiment, the fluorescence emitted from the capillary is prevented from overlapping the fluorescence emitted from the neighboring capillary so that the crosstalk can be restricted to a substantially negligible level.

Incidentally, when the fluorescence proceeds into the surface of the substrate with an angle less than an angle for total reflection, the fluorescence is reflected by the substrate. However, an amount of a part of the fluorescence proceeding into the surface of the substrate with the angle less than the angle for total reflection is small.

The embodiments of the invention are described above, however, the invention is not restricted to the above embodiments, and it can be understood by the ordinary skilled in the art that the invention can be modified variously in the scope of claims.

It should be further understood by those skilled in the art that although the foregoing description has been made on embodiments of the invention, the invention is not limited thereto and various changes and modifications may be made without departing from the spirit of the invention and the scope of the appended claims.

1. An electrophoresis apparatus comprising capillaries for containing therein fluorescence-labeled substances, and a sensor for irradiating the capillaries with exciting light and detecting fluorescences,
wherein the sensor has a substrate including a datum surface for holding thereon the capillaries, and a groove sinking from the datum surface, and the groove has a plurality of reflecting surfaces for reflecting thereon the fluorescences emitted from the capillaries by a plurality of times.

2. An electrophoresis apparatus according to claim 1, wherein the reflecting surfaces form a V-shape.

3. An electrophoresis apparatus according to claim 1, wherein the reflecting surfaces are inclined with respect to each other and with respect to the datum surface.

4. An electrophoresis apparatus according to claim 1, wherein the reflecting surfaces includes two of the reflecting surfaces facing to each other, and the other one of the reflecting surfaces extending between the two of the reflecting surfaces and being inclined with respect to the datum surface.

5. An electrophoresis apparatus according to claim 1, wherein the capillaries are arranged in an optically transmissive medium other than the atmosphere in the sensor.

6. An electrophoresis apparatus comprising capillaries for containing therein fluorescence-labeled substances, and a sensor for irradiating the capillaries with exciting light and detecting fluorescences,
wherein the capillaries are arranged on the substrate and in an optically transmissive medium other than the atmosphere in the sensor, and the substrate is formed of a transparent material whose refractive index is substantially equal to a refractive index of the optically transmissive medium.

7. An electrophoresis apparatus for detecting a substance with marking by fluorochrome by detecting a fluorescence emitted by the fluorochrome in a specimen, comprising,
capillaries each of which is capable of passing therein the substance,
a light source for irradiating the capillaries with a light so that the fluorochrome generates the fluorescence,
a sensor for detecting the fluorescence emitted from each of the capillaries, and
a substrate having a base planar surface along which parts of the capillaries are capable of being arranged to hold the other parts of the capillaries so that the other parts of the capillaries are capable of being irradiated with the light,
wherein the substrate has a fluorescence receiving surface arranged to receive thereon the fluorescences emitted from the other parts of the capillaries, prevented from extending perpendicular to the base planar surface, and prevented from extending parallel to the base planar surface.

8. An electrophoresis apparatus according to claim 7, wherein the substrate has another surface arranged to receive the fluorescences reflected by the fluorescence receiving surface so that the fluorescences emitted from the other parts of the capillaries are capable of being reflected by the substrate by at least two times when being prevented from reaching at least one of the capillaries.

9. An electrophoresis apparatus according to claim 7, wherein as seen in a direction perpendicular to the base planar surface, the fluorescence receiving surface is arranged to overlap the other parts of the capillaries.

10. An electrophoresis apparatus according to claim 7, wherein the capillaries have respective outer peripheral surface areas prevented from being coated with a solid resin, the other parts of the capillaries are included by the outer peripheral surface areas as seen in a direction perpendicular to longitudinal directions of the capillaries, and at least parts of the outer peripheral surface areas overlap the fluorescence receiving surface as seen in a direction perpendicular to the base planar surface.

11. An electrophoresis apparatus according to claim 8, wherein the capillaries have respective outer peripheral surface areas prevented from being coated with a solid resin, the other parts of the capillaries are included by the outer peripheral surface areas as seen in a direction perpendicular to longitudinal directions of the capillaries, and at least parts of the outer peripheral surface areas overlap the another surface as seen in a direction perpendicular to the base planar surface.

12. An electrophoresis apparatus according to claim 7, wherein the fluorescence receiving surface is prevented from extending parallel to longitudinal directions of the parts of the capillaries.

13. An electrophoresis apparatus according to claim 7, wherein the fluorescence receiving surface is prevented from extending parallel to a direction in which the parts of the capillaries are juxtaposed to each other on the base planar surface.

14. An electrophoresis apparatus according to claim 8, wherein the fluorescence receiving surface and the another surface form a groove on the substrate with respect to the base planar surface.

15. An electrophoresis apparatus according to claim 7, wherein an optically transmissive medium other than the atmosphere is capable of being received between the fluorescence receiving surface and the other parts of the capillaries.

16. An electrophoresis apparatus according to claim 15, wherein the optically transmissive medium is a liquid.

17. An electrophoresis apparatus according to claim 15, wherein a difference in refractive index between a material forming the fluorescence receiving surface and the optically transmissive medium is smaller than a difference in refractive index between a material forming the fluorescence receiving surface and the atmosphere.

18. An electrophoresis apparatus for detecting a substance with marking by fluorochrome by detecting a fluorescence emitted by the fluorochrome in a specimen, comprising,
capillaries each of which is capable of passing therein the substance,
a light source for irradiating the capillaries with a light so that the fluorochrome generates the fluorescence,
a sensor for detecting the fluorescence emitted from each of the capillaries, and
a substrate having a base planar surface along which parts of the capillaries are capable of being arranged to hold the other parts of the capillaries so that the other parts of the capillaries are capable of being irradiated with the light,
wherein an optically transmissive medium other than the atmosphere is capable of being received between the fluorescence receiving surface and the other parts of the capillaries, and
a difference in refractive index between a material forming the fluorescence receiving surface and the optically transmissive medium is smaller than a difference in refractive index between a material forming the fluorescence receiving surface and the atmosphere.
